(19) United States
(12) Patent Application Publication
(10) Pub. No.: US 2009/0292736 A1
(43) Pub. Date: Nov. 26, 2009

(54) ON DEMAND NETWORK ACTIVITY REPORTING THROUGH A DYNAMIC FILE SYSTEM AND METHOD

(76) Inventors: Matthew Scott Wood, Salt Lake City, UT (US); Paal Tveit, Salt Lake City, UT (US); Brian Edginton, West Jordan, UT (US); Steve Shillingford, Lindon, UT (US); James Brown, Linden, UT (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 12/126,619

(22) Filed: May 23, 2008

(51) Int. Cl. G06F 17/30

(52) U.S. Cl. 707/200

(57) ABSTRACT

A method, apparatus and a system of on demand network activity reporting through a dynamic file system and method are disclosed. In one embodiment, a method includes forming a root level selection guide based on a set of criteria associated with an activity through a network that is captured and stored on a storage device associated with a network appliance, refreshing listings of a sub-directory of the root level selection guide dynamically based on the activity through the network stored on the storage device when an option is selected in the root level selection guide, and creating a packet capture file based on a current state of the activity through the network when one of the listings of the sub-directory of the root level selection guide is selected. The method may include automatically referencing a database having the activity through the network when creating the packet capture file.

### FIELD OF TECHNOLOGY

This disclosure relates generally to an enterprise method, a technical field of software and/or hardware technology and, in one example embodiment, a method, apparatus and a system of on demand network activity reporting through a dynamic file system and method.

### BACKGROUND

An entity may monitor activities of users of a portion of a network that is controlled by the entity. The entity may store data (e.g. a meta data, an artifact, a header information, etc.) regarding this activity in a database (a SQL database, a MySQL database, etc.). The entity may employ a supervisor to monitor activity of the users. The supervisor may require a report of a current and/or recent network activity. Furthermore, the supervisor may require only a specific set of network data (e.g. a history of websites visited by a particular user during a specific period of time, an analysis of a content of an artifact attached to an electronic transmission, etc.).

The supervisor may not be able to generate the report. The supervisor may have to request the report from a specialist in network administration. The specialist in network administration may need time to generate the report. A process of manually generating the report may waste human and/or financial resources of the entity. Thus, generating a report of the network activity may be a difficult and complex task.

In addition, the supervisor may require a report of a current data because time may be of an essence. For example, the supervisor may suspect a particular user of transmitting a trade secret of the entity to an outside electronic mail account. Unfortunately, the supervisor may not be able to obtain the report in time. As a result, a delay in analyzing the report may result in the trade secret being compromised.

A method, apparatus and a system of on demand network activity reporting through a dynamic file system and method are disclosed. In one aspect, a method includes forming a root level selection guide based on a set of criteria associated with an activity through a network that is captured and stored on a storage device associated with a network appliance, refreshing listings of a sub-directory of the root level selection guide dynamically based on the activity through the network stored on the storage device when an option is selected in the root level selection guide, and creating a packet capture file based on a current state of the activity through the network when one of the listings of the sub-directory of the root level selection guide is selected.

The method may include automatically referencing a database having the activity through the network when creating the packet capture file. The criteria defines parameters that may indicate network activity and which include an Ethernet source address, an Ethernet destination address, an Ethernet protocol from Ethernet header, a source IP address, a destination IP address, an IP flag, a header length, an IP protocol, an IP options (e.g., out of bound messages, may depend on application), a payload length, a next header, a source port, a destination port, a sequence number, an acknowledgement number, a TCP flag, and/or a TCP option from a TCP header, and/or a broadcast data. The root level selection guide and/or the sub-directory of the root level selection guide may be arranged in a file system format in which selections of the set of criteria defining the packet capture file are selected in a hierarchical fashion.

The packet capture file may include packet data associated with criteria based on elected ones of the root level selection guide and/or the sub-directory of the root level selection guide. The method may be performed on the network appliance and/or a data processing system communicatively coupled with the network appliance.

The network appliance may continuously monitor activities of users of the network and places in the storage device relevant meta-data (e.g., header information such as source IP address, MAC address, destination IP address, etc.) and/or payload data (e.g., artifacts such as files, video clips, audio files, etc.) based on the monitoring of the activity through the network. The method may include removing certain ones of the listings when a sliding window of last recently used packets of the activity through the network is discarded from the storage device.

In another aspect, a file system includes a root level selection guide formed based on a set of criteria associated with an activity through a network that is captured and stored on a storage device associated with a network appliance, a sub-directory of the root level selection guide having listings that are dynamically refreshed based on the activity through the network stored on the storage device when an option is selected in the root level selection guide, and a packet capture file created based on a current state of the activity through the network when one of the listings of the sub-directory of the root level selection guide is selected.

The file system may include a database that is automatically referenced having the activity through the network when creating the packet capture file. The criteria defines parameters that indicate network activity and which may include an Ethernet source address, an Ethernet destination address, an Ethernet protocol from Ethernet header, a source IP address, a destination IP address, an IP flag, a header length, an IP protocol, an IP options (e.g., out of bound messages, may depend on application), a payload length, a next header, a source port, a destination port, a sequence number, an acknowledgement number, a TCP flag, and a TCP option from a TCP header, and/or a broadcast data.

The root level selection guide and/or the sub-directory of the root level selection guide may be arranged in a file system format in which selections of the set of criteria defining the packet capture file are selected in a hierarchical fashion. The packet capture file may include packet data associated with criteria based on selected ones of the root level selection guide and/or the sub-directory of the root level selection guide. The method may be performed the network appliance and/or a data processing system communicatively coupled with the network appliance.

The network appliance may continuously monitor activities of users of the network and places in the storage device relevant meta-data (e.g., header information such as source IP address, MAC address, destination IP address, etc.) and/or payload data (e.g., artifacts such as files, video clips, audio files, etc.) based on the monitoring of the activity through the network. The certain ones of the listings may be removed when a sliding window of last recently used packets of the activity through the network are discarded from the storage device.

In yet another aspect, a method includes creating a packet capture file that is customized based on responses to a navigation of a file system by a user, forming directories of the file system based on information stored in a storage device having current and historical activity information of a plurality of users traversing a network, periodically refreshing the formed directories based on changes in the information stored in the storage device.

The method may include forming a root level selection guide of the directories based on a set of criteria associated with the current and/or historical activity through the network that may be captured and/or stored on the storage device. The method may refresh listings of a sub-directory of the directories dynamically based on the activity through the network stored on the storage device when an option is selected in the root level selection guide. The method may also include automatically referencing a database having the activity through the network when creating the packet capture file.

The criteria defines parameters that may indicate network activity and which include an Ethernet source address, an Ethernet destination address, an Ethernet protocol from Ethernet header, a source IP address, a destination IP address, an IP flag, a header length, an IP protocol, an IP options (e.g., out of bound messages, may depend on application), a payload length, a next header, a source port, a destination port, a sequence number, an acknowledgement number, a TCP flag, and a TCP option from a TCP header, and/or a broadcast data.

The method may include removing certain ones of the formed directories when a sliding window of last recently used packets of the current and/or historical activity through the network is discarded from the storage device.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view illustrating a data communication between client device 106A-N and a visibility module 104 through a network 102, according to one embodiment.

FIG. 2 is an exploded view of the visibility module, according to one embodiment.

FIG. 3 is a flow diagram illustrating the flow of creating a packet capture file, according to one embodiment.

FIG. 4 is a diagrammatic system view of a data processing system in which any of the embodiments disclosed herein may be performed, according to one embodiment.

FIG. 5 is a process flow of forming a root level selection guide based on a set of criteria associated with an activity through a network, according to one embodiment.

FIG. 6 is a process flow of automatically referencing a database having the activity through the network when creating the packet capture file, according to one embodiment.

Other features of the present embodiments will be apparent from the accompanying drawings and from the detailed description that follows.

### DETAILED DESCRIPTION

A method, apparatus and a system of on demand network activity reporting through a dynamic file system and method are disclosed. Although the present embodiments have been described with reference to specific example embodiments, it will be evident that various modifications and changes may be made to these embodiments without departing from the broader spirit and scope of the various embodiments.

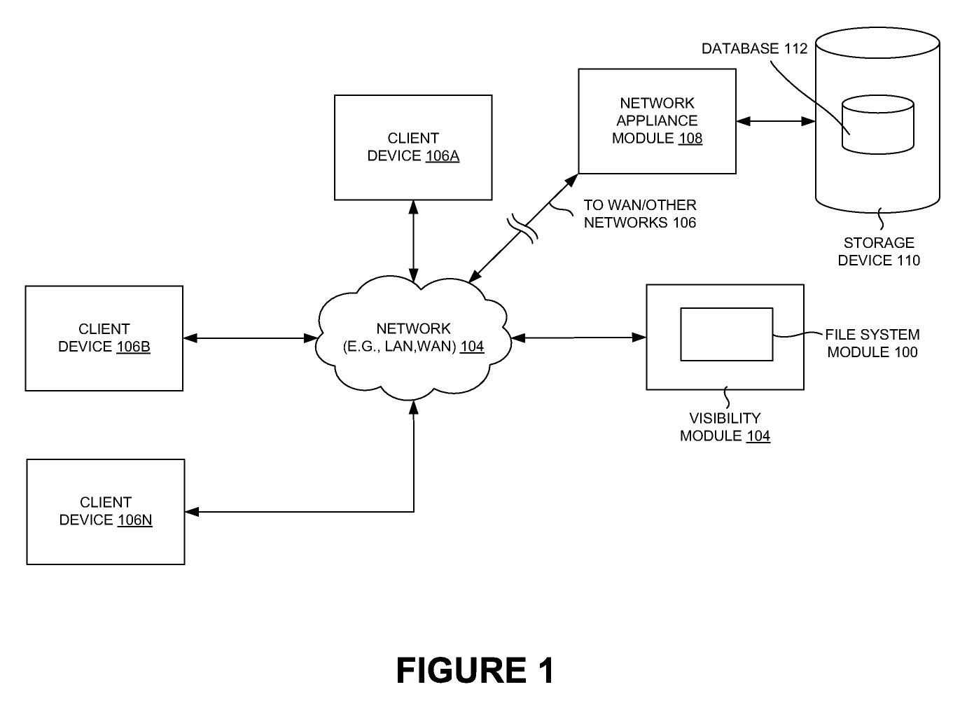

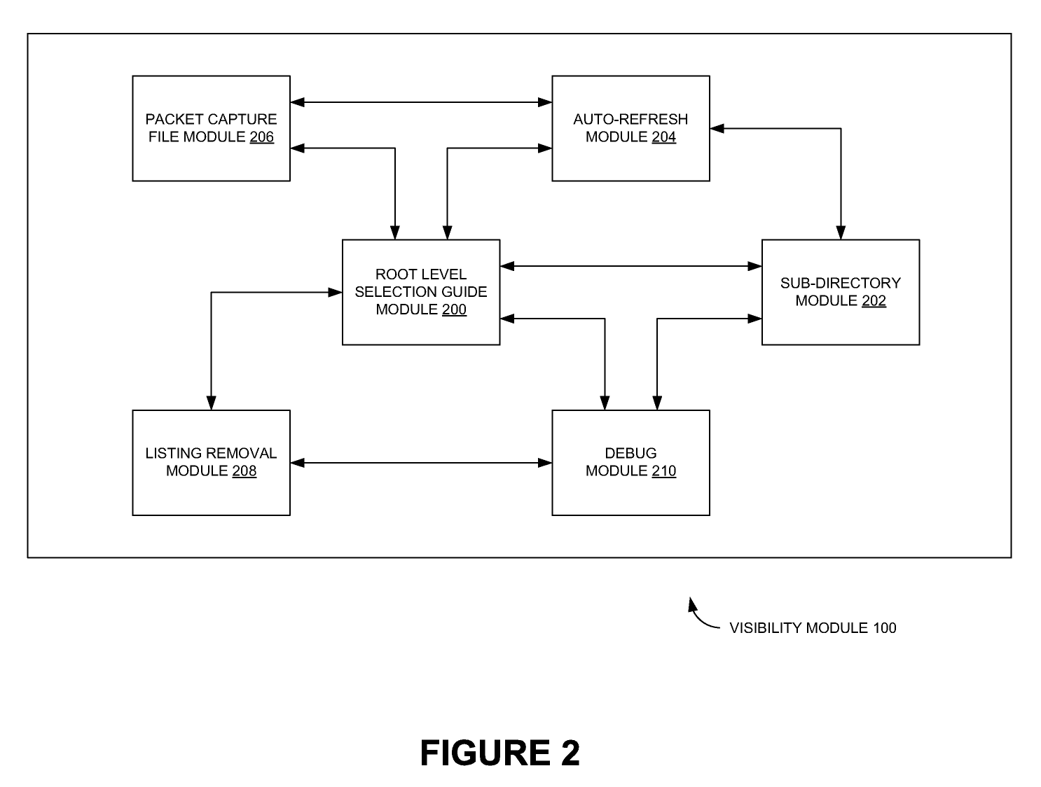

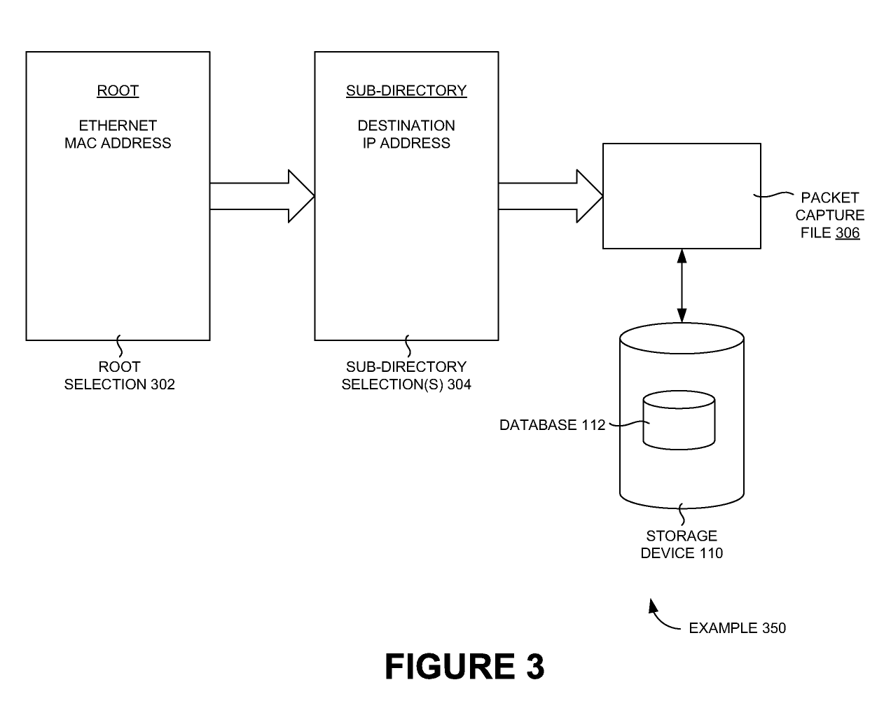

In one embodiment, a method includes forming a root level selection guide (e.g., using the root level selection guide module 200 of FIG. 2) based on a set of criteria associated with an activity through a network (e.g., the network 102 of FIG. 1) that is captured and stored on a storage device (e.g., the storage device 110 of FIG. 1) associated with a network appliance (e.g., the network appliance 108 of FIG. 1), refreshing listings of a sub-directory of the root level selection guide (e.g., using the sub-directory module 202 of FIG. 2) dynamically based on the activity through the network 102 stored on the storage device 110 when an option is selected in the root level selection guide (e.g., using the root level selection guide module 200 of FIG. 2), and creating a packet capture file (e.g., the packet capture file 306 of FIG. 3) based on a current state of the activity (e.g., using the packet capture file module 206 of FIG. 2) through the network 102 when one of the listings of the sub-directory of the root level selection guide is selected (e.g., using the root level selection guide module 200 of FIG. 2). The method may include automatically referencing a database (e.g., the database 112 of FIG. 1) having the activity through the network 102 when creating the packet capture file 306.

In another embodiment, a file system includes a root level selection guide formed based on a set of criteria (e.g., using the root level selection guide module 200 of FIG. 2) associated with an activity through a network (e.g., the network 102 of FIG. 1) that is captured and stored on a storage device (e.g., the storage device 110 of FIG. 1) associated with a network appliance (e.g., the network appliance 108 of FIG. 1), a sub-directory of the root level selection guide having listings that are dynamically refreshed (e.g., using the sub-directory module 202 of FIG. 2) based on the activity through the network 102 stored on the storage device 110 when an option is selected in the root level selection guide, and a packet capture file (e.g., the packet capture file 306 of FIG. 3) created based on a current state of the activity (e.g., using the packet capture file module 206 of FIG. 2) through the network 102 when one of the listings of the sub-directory of the root level selection guide is selected (e.g., using the root level selection guide module 200 of FIG. 2).

In yet another embodiment, a method includes creating a packet capture file (e.g., the packet capture file 306 of FIG. 3) that is customized based on responses to a navigation of a file system (e.g., using the packet capture file module 206 of FIG. 2) by a user, forming directories of the file system based on information stored in a storage device (e.g., the storage device 110 of FIG. 1) having current and historical activity information of users traversing a network (e.g., the network 102 of FIG. 1), periodically refreshing the formed directories based on changes in the information stored in the storage device 110.

FIG. 1 is a system view illustrating a data communication between client device 106A-N and a visibility module 104 through a network 102, according to one embodiment. Particularly, FIG. 1 illustrates a file system module 100, a network (e.g., LAN, WAN) 102, a visibility module 104, a client device 106A-N, a network appliance 108, a storage device 110, and a database 112, according to one embodiment.

The file system module 100 may form directories of a file system based on the information stored in the storage device 110 which may have current and/or historical activity information (e.g., log file) of users. The network 102 (e.g., LAN, WAN, mobile, telecommunications, internet, intranet, WiFi and/or ZigBee network, etc.) may enable communication for the client device 106A-N. The visibility module 104 may perform visibility analysis (e.g., such as what users communicate on the internet in an organization) of users (e.g., may be employees) on data flowing across the network 102. The client device 106A-N may be a data processing system (e.g., a computer, mobile devices, laptop, etc.) in the network that may communicate (e.g., transfer data, receive data, browse, etc.) with outside world.

The network appliance 108 may monitor activities of users (e.g., employees of the organization) of the network and places in the storage device relevant meta-data (e.g., header information such as source IP address, MAC address, destination IP address, etc.) and payload data (e.g., artifacts such as files, video clips, audio files, etc.) based on the monitoring of the activity through the network. The storage device 110 may be storage medium (e.g., hard disk, flash drive, server, etc.) that may process (e.g., store, retrieve, etc.) the data (e.g., meta-data, information, etc.). The database 112 may be an organized collection of the meta-data information communicated by the network appliance 108.

In example embodiment, the client device 106A-N communications may be monitored by the network appliance 108 in association with the visibility module 104 in the network 102. The network appliance 108 may monitor using the meta-data content present in the data (e.g., may be instant message data, email, etc.) and may store the meta-data content in the database 112 of the storage device. The visibility module 104 may include the file system module which may arrange the root level selection guide and the sub-directory of the root level selection guide in the file system format.

In one embodiment, the network appliance 108 may continuously monitors activities of users of the network 102 and/or places in the storage device 110 relevant meta-data (e.g., header information such as source IP address, MAC address, destination IP address, etc.) and/or payload data (e.g., artifacts such as files, video clips, audio files, etc.) based on the monitoring of the activity through the network 102. The network appliance 108 may continuously monitors activities of users of the network 102 and places in the storage device relevant meta-data (e.g., header information such as source IP address, MAC address, destination IP address, etc.) and/or payload data (e.g., artifacts such as files, video clips, audio files, etc.) based on the monitoring of the activity through the network 102.

FIG. 2 is an exploded view of the visibility module 104, according to one embodiment. Particularly, FIG. 2 illustrates a root level selection guide module 200, a sub-directory module 202, a auto-refresh module 204, a packet capture file module 206, a listing removal module 208, and a debug module 210.

The root level selection guide module 200 may form a root level selection guide based on a set of criteria associated with an activity through the network 102 (e.g., using the MAC address, Ethernet, etc.) that is captured and/or stored on the storage device 110 (e.g., in a database 112) associated with the network appliance 108. The sub-directory module 202 may form a sub-directory listings (e.g., destination IP address, etc.) based on a set of criteria associated with an activity (e.g. of the client device 106A-N of FIG. 1) through the network 102 that is captured and/or stored on the storage device 106 (e.g., in a database 112) associated with the network appliance 108.

The auto-refresh module 204 may refresh listings of a sub-directory (e.g., IP address, etc.) of the root level selection guide dynamically based on the activity through the network 102 stored on the storage device 106 when an option is selected in the root level selection guide. The packet capture file module 206 may create a packet capture file based on a current state of the activity through the network 102 when one of the listings of the sub-directory of the root level selection guide is selected. The listing removal module 208 may remove certain ones of the listings when sliding windows of last recently used packets of the activity through the network 102 are discarded from the storage device 110. The debug module 210 may debug in any inconsistencies found in root level selection guide module 200.

In example embodiment, the root level selection guide module 200 may communicate with the sub-directory module 202, the auto-refresh module 204, the packet capture file module 206, listing removal module 208, and the debug module 210. The auto-refresh module 204 may communicate with the sub-directory module 202 and the packet capture file module 206. The debug module 210 may communicate with the listing removal module 208, and the sub-directory module 202, according to one embodiment.

In one embodiment, the root level selection guide based on a set of criteria associated with an activity may be formed (e.g., using the root level selection guide module 200 of FIG. 2) through the network 102 that is captured and stored on the storage device 110 associated with the network appliance 108. Listings of a sub-directory of the root level selection guide (e.g., using the sub-directory module 202 of FIG. 2) may be refreshed dynamically based on the activity through the network 102 stored on the storage device 110 when an option is selected in the root level selection guide (e.g., using the root level selection guide module 200 of FIG. 2).

The packet capture file 306 based on a current state of the activity may be created (e.g., using the packet capture file module 206 of FIG. 2) through the network 102 when one of the listings of the sub-directory of the root level selection guide is selected (e.g., using the root level selection guide module 200 of FIG. 2). Certain ones of the listings may be removed (e.g., using the listing removal module 208 of FIG. 2) when a sliding window of last recently used packets of the activity through the network 102 are discarded from the storage device 110. The root level selection guide may be formed based on a set of criteria (e.g., using the root level selection guide module 200 of FIG. 2) associated with an activity through the network 102 that is captured and/or stored on the storage device 110 associated with the network 102 appliance.

The sub-directory of the root level selection guide having listings that may be dynamically refreshed (e.g., using the auto-refresh module 204 of FIG. 2) based on the activity through the network 102 stored on the storage device 110 when an option is selected in the root level selection guide. The packet capture file 306 may be created (e.g., using the packet capture file module 206 of FIG. 2) based on a current state of the activity through the network when one of the listings of the sub-directory of the root level selection guide is selected (e.g., using the root level selection guide module 200 of FIG. 2).

The root level selection guide and/or the sub-directory of the root level selection guide may be arranged (e.g., using the file system module 100 of FIG. 1) in a file system format in which selections of the set of criteria defining the packet capture file 306 are selected in a hierarchical fashion (e.g., using the packet capture file module 206 of FIG. 2). The root level selection guide of the directories based on a set of criteria associated with the current and historical activity may be formed (e.g., using the root level selection guide module 200 of FIG. 2) through the network 102 that may be captured and/or stored on the storage device 110.

Listings of the sub-directory of the directories dynamically based on the activity may be refreshed (e.g., using the auto-refresh module 204 of FIG. 2) through the network 102 stored on the storage device 110 when an option is selected in the root level selection guide. Certain ones of the formed directories may be removed (e.g., using the listing removal module 208 of FIG. 2) when a sliding window of last recently used packets of the current and/or historical activity through the network 102 are discarded from the storage device 110 (e.g., using the visibility module 104 of FIG. 1).

FIG. 3 is a flow diagram illustrating the flow of creating a packet capture file, according to one embodiment. In operation 302, the root selection guide may be formed based on a set of criteria associated with an activity through the network 102 that is captured and/or stored on the storage device 110 associated with the network appliance 108. In operation 304, listings of a sub-directory of the root level selection guide may be refreshed dynamically based on the activity through the network 102 stored on the storage device 110 when an option is selected in the root level selection guide. In operation 306, a packet capture file may be created based on a current state of the activity through the network 102 when one of the listings of the sub-directory of the root level selection guide is selected.

In one embodiment, the database 112 having the activity may be automatically referenced through the network 102 when creating the packet capture file 306 (e.g., using the visibility module 104 of FIG. 1). The criteria defines parameters that may indicate network activity and/or which includes an Ethernet source address, an Ethernet destination address, an Ethernet protocol from Ethernet header, a source IP address, a destination IP address, an IP flag, a header length, an IP protocol, an IP options (e.g., out of bound messages, may depend on application), a payload length, a next header, a source port, a destination port, a sequence number, an acknowledgement number, a TCP flag, and a TCP option from a TCP header, and/or a broadcast data (e.g., as illustrated in FIG. 3).

The root level selection guide and/or the sub-directory of the root level selection guide may be arranged in a file system format (e.g., using the file system module 100 of FIG. 1) in which selections of the set of criteria defining the packet capture file are selected in a hierarchical fashion. The packet capture file 306 may include packet data associated with criteria based on selected ones of the root level selection guide and/or the sub-directory of the root level selection guide. The method may be performed on the network appliance 108 and/or a data processing system communicatively coupled with the network appliance 108. The database that may be automatically referenced having the activity through the network 102 when creating the packet capture file 306.

The packet capture file 306 may include packet data associated with criteria based on selected ones of the root level selection guide and/or the sub-directory of the root level selection guide. The method may be performed on the network appliance 108 and/or the data processing system communicatively coupled with the network appliance 108. The packet capture file 306 that may be customized based on responses created to a navigation of a file system by a user. Directories of the file system may be formed based on information stored in the storage device 110 having current and/or historical activity information of users traversing the network 102. The formed directories may be periodically refreshed based on changes in the information stored in the storage device.

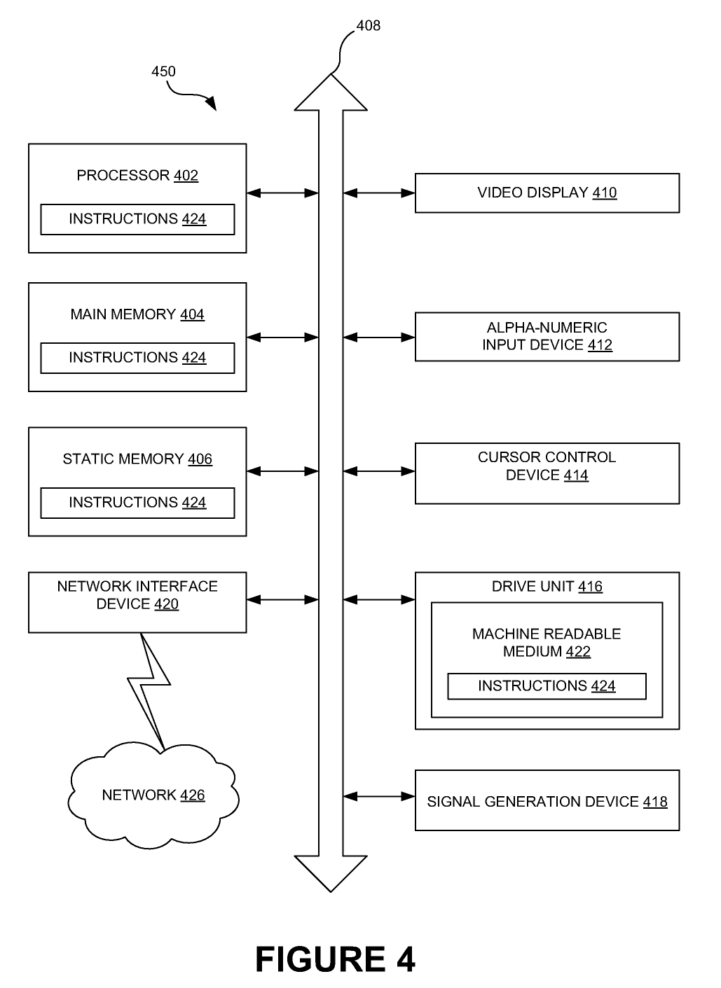

FIG. 4 is a diagrammatic system view of a data processing system in which any of the embodiments disclosed herein may be performed, according to one embodiment.

Particularly, the diagrammatic system view 400 of FIG. 4 illustrates a processor 402, a main memory 404, a static memory 406, a bus 408, a video display 410, an alpha-numeric input device 412, a cursor control device 414, a drive unit 416, a signal generation device 418, a network interface device 420, a machine readable medium 422, instructions 424, and a network 426, according to one embodiment.

The diagrammatic system view 400 may indicate a personal computer and/or the data processing system in which one or more operations disclosed herein are performed. The processor 402 may be a microprocessor, a state machine, an application specific integrated circuit, a field programmable gate array, etc. (e.g., Intel® Pentium® processor). The main memory 404 may be a dynamic random access memory and/or a primary memory of a computer system.

The static memory 406 may be a hard drive, a flash drive, and/or other memory information associated with the data processing system. The bus 408 may be an interconnection between various circuits and/or structures of the data processing system. The video display 410 may provide graphical representation of information on the data processing system. The alpha-numeric input device 412 may be a keypad, a keyboard and/or any other input device of text (e.g., a special device to aid the physically handicapped).

The cursor control device 414 may be a pointing device such as a mouse. The drive unit 416 may be the hard drive, a storage system, and/or other longer term storage subsystem. The signal generation device 418 may be a bios and/or a functional operating system of the data processing system. The network interface device 420 may be a device that performs interface functions such as code conversion, protocol conversion and/or buffering required for communication to and from the network 426. The machine readable medium 422 may provide instructions on which any of the methods disclosed herein may be performed. The instructions 424 may provide source code and/or data code to the processor 402 to enable any one or more operations disclosed herein.

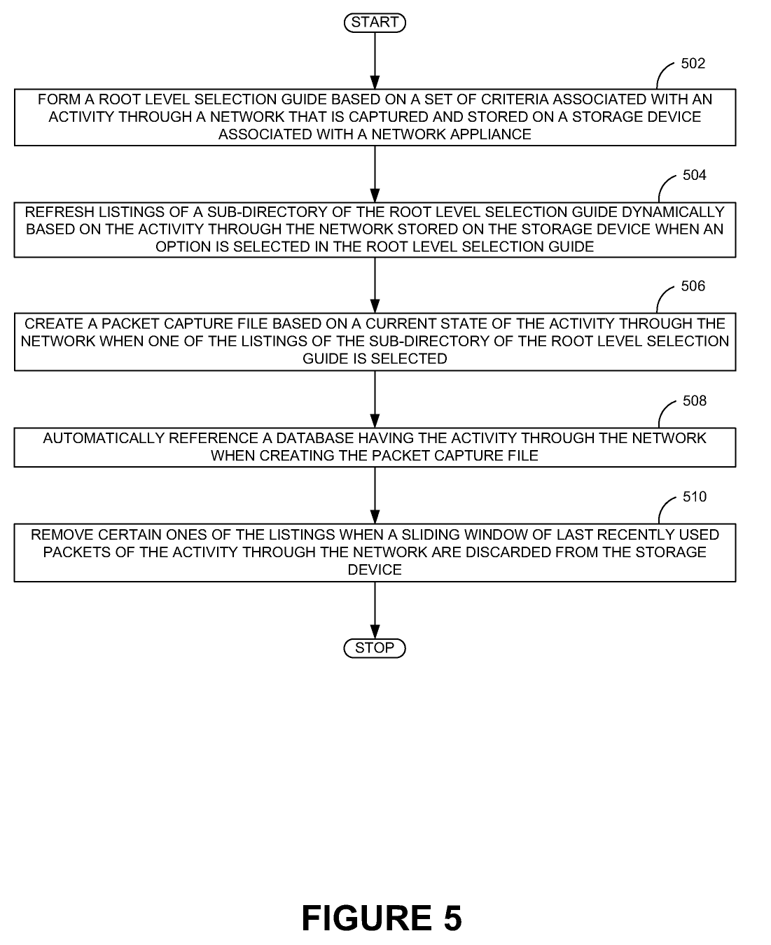

FIG. 5 is a process flow of forming a root level selection guide based on a set of criteria associated with an activity through a network (e.g., the network 102 of FIG. 1), according to one embodiment. In operation 502, a root level selection guide based on a set of criteria associated with an activity may be formed (e.g., using the root level selection guide module 200 of FIG. 2) through the network 102 that is captured and/or stored on a storage device (e.g., the storage device 110 of FIG. 1) associated with a network appliance (e.g., the network appliance 108 of FIG. 1). In operation 504, listings of a sub-directory of the root level selection guide may be refreshed (e.g., using the auto-refresh module 204 of FIG. 2) dynamically based on the activity through the network 102 stored on the storage device 110 when an option is selected in the root level selection guide.

In operation 506, a packet capture file (e.g., the packet capture file 306 of FIG. 3) based on a current state of the activity may be created (e.g., using the packet capture file module 206 of FIG. 2) through the network 102 when one of the listings of the sub-directory of the root level selection guide is selected (e.g., using the sub-directory module 202 of FIG. 2). In operation 508, a database having the activity may be automatically referenced through the network 102 when creating the packet capture file 306 (e.g., using the packet capture file module 206 of FIG. 2). In operation 510, certain ones of the listings may be removed (e.g., using the listing removal module 208 of FIG. 2) when a sliding window of last recently used packets of the activity through the network 102 are discarded from the storage device 110 (e.g., using the visibility module 104 of FIG. 1).

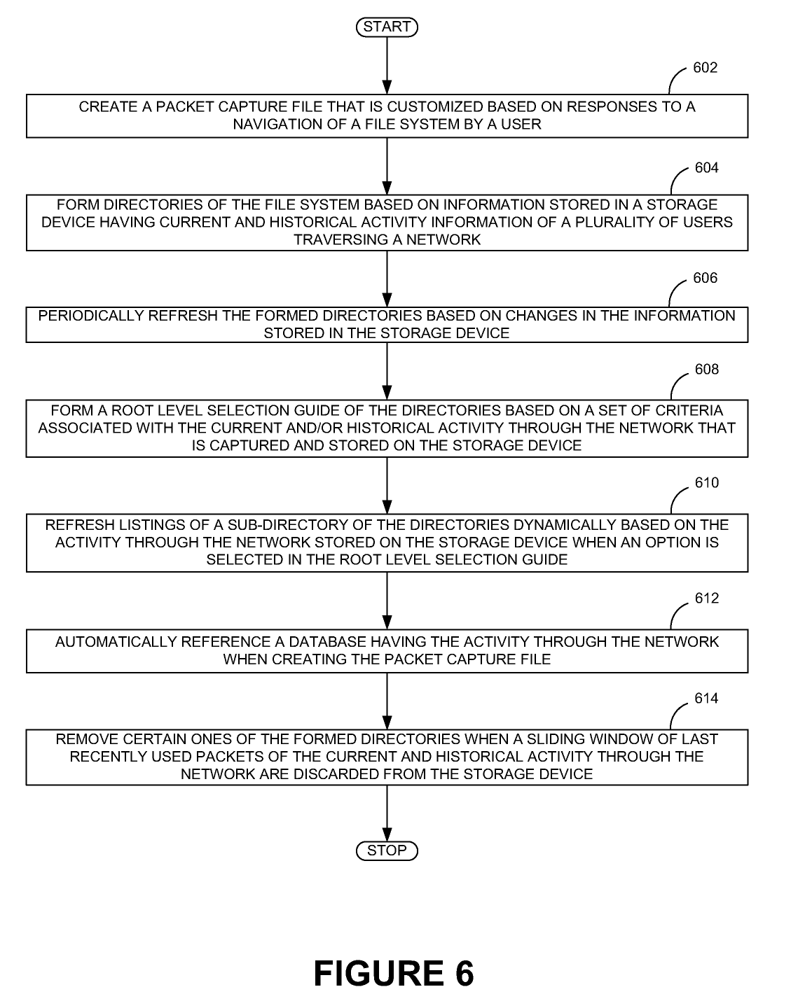

FIG. 6 is a process flow of automatically referencing a database having the activity through the network 102 when creating the packet capture file 306, according to one embodiment. In operation 602, a packet capture file (e.g., the packet capture file 306 of FIG. 3) that is customized based on responses may be created (e.g., using the packet capture file module 206 of FIG. 2) to a navigation of a file system by a user. In operation 604, directories of the file system may be formed (e.g., e.g., using the file system module 100 of FIG. 1) based on information stored in a storage device (e.g., the storage device 110 of FIG. 1) having current and/or historical activity information of users traversing a network (e.g., the network 102 of FIG. 1). In operation 606, the formed directories may be periodically refreshed (e.g., using the auto-refresh module 204 of FIG. 2) based on changes in the information stored in the storage device 110.

In operation 608, a root level selection guide of the directories based on a set of criteria associated with the current and/or historical activity may be formed through the network 102 that is captured and/or stored on the storage device 110. In operation 610, listings of a sub-directory of the directories may be refreshed (e.g., using the auto-refresh module 204 of FIG. 2) dynamically based on the activity through the network 102 stored on the storage device 110 when an option is selected in the root level selection guide. In operation 612, a database having the activity may be automatically refreshed (e.g., using the auto-refresh module 204 of FIG. 2) through the network 102 when creating the packet capture file 306.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

Particularly, the file system module 100, the visibility module 104, the root level selection guide module 200, the sub-directory module 202, the auto-refresh module 204, the packet capture file module 206, the listing removal module 208, and the debug module 210 of FIG. 1-6 may be enabled using software and/or using transistors, logic gates, and electrical circuits (e.g., application specific integrated ASIC circuitry) such as a file system circuit, a visibility circuit, a root level selection guide circuit, a sub directory circuit, an auto-refresh circuit, a packet capture file circuit, a listing removal circuit, and a debug circuit, and other circuit.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
forming a root level selection guide based on a set of criteria associated with an activity through a network that is captured and stored on a storage device associated with a network appliance;
refreshing listings of a sub-directory of the root level selection guide dynamically based on the activity through the network stored on the storage device when an option is selected in the root level selection guide; and
creating a packet capture file based on a current state of the activity through the network when one of the listings of the sub-directory of the root level selection guide is selected.

2. The method of claim 1 further comprising: automatically referencing a database having the activity through the network when creating the packet capture file.

3. The method of claim 1 wherein the criteria defines parameters that indicate network activity and which include at least one of an Ethernet source address, an Ethernet destination address, an Ethernet protocol from Ethernet header, a source IP address, a destination IP address, an IP flag, a header length, an IP protocol, an IP options (e.g., out of bound messages, may depend on application), a payload length, a next header, a source port, a destination port, a sequence number, an acknowledgement number, a TCP flag, and a TCP option from a TCP header, and a broadcast data.

4. The method of claim 1 wherein the root level selection guide and the sub-directory of the root level selection guide are arranged in a file system format in which selections of the set of criteria defining the packet capture file are selected in a hierarchical fashion.

5. The method of claim 1 wherein the packet capture file includes packet data associated with criteria based on selected ones of the root level selection guide and the sub-directory of the root level selection guide, and wherein the method is performed on at least one of the network appliance and a data processing system communicatively coupled with the network appliance.

6. The method of claim 1 wherein the network appliance continuously monitors activities of a plurality of users of the network and places in the storage device relevant meta-data (e.g., header information such as source IP address, MAC address, destination IP address, etc.) and payload data (e.g., artifacts such as files, video clips, audio files, etc.) based on the monitoring of the activity through the network.

7. The method of claim 1 further comprising removing certain ones of the listings when a sliding window of last recently used packets of the activity through the network are discarded from the storage device.

8. The method of claim 1 in a form of a machine-readable medium embodying a set of instructions that, when executed by a machine, causes the machine to perform the method of claim 1.

9. A file system comprising:
a root level selection guide formed based on a set of criteria associated with an activity through a network that is captured and stored on a storage device associated with a network appliance;
a sub-directory of the root level selection guide having listings that are dynamically refreshed based on the activity through the network stored on the storage device when an option is selected in the root level selection guide; and
a packet capture file created based on a current state of the activity through the network when one of the listings of the sub-directory of the root level selection guide is selected.

10. The file system of claim 9 further comprising: a database that is automatically referenced having the activity through the network when creating the packet capture file.

11. The file system of claim 9 wherein the criteria defines parameters that indicate network activity and which include at least one of an Ethernet source address, an Ethernet destination address, an Ethernet protocol from Ethernet header, a source IP address, a destination IP address, an IP flag, a header length, an IP protocol, an IP options (e.g., out of bound messages, may depend on application), a payload length, a next header, a source port, a destination port, a sequence number, an acknowledgement number, a TCP flag, and a TCP option from a TCP header, and a broadcast data.

12. The file system of claim 9 wherein the root level selection guide and the sub-directory of the root level selection guide are arranged in a file system format in which selections of the set of criteria defining the packet capture file are selected in a hierarchical fashion.

13. The file system of claim 9 wherein the packet capture file includes packet data associated with criteria based on selected ones of the root level selection guide and the sub-directory of the root level selection guide, and wherein a method is performed on at least one of the network appliance and a data processing system communicatively coupled with the network appliance.

14. The file system of claim 9 wherein the network appliance continuously monitors activities of a plurality of users of the network and places in the storage device relevant meta-data (e.g., header information such as source IP address, MAC address, destination IP address, etc.) and payload data (e.g., artifacts such as files, video clips, audio files, etc.) based on the monitoring of the activity through the network.

15. The file system of claim 9 wherein certain ones of the listings are removed when a sliding window of last recently used packets of the activity through the network are discarded from the storage device.

16. A method comprising:
creating a packet capture file that is customized based on responses to a navigation of a file system by a user;
forming directories of the file system based on information stored in a storage device having current and historical activity information of a plurality of users traversing a network;
periodically refreshing the formed directories based on changes in the information stored in the storage device.

17. The method of claim 16 further comprising
forming a root level selection guide of the directories based on a set of criteria associated with the current and historical activity through the network that is captured and stored on the storage device; and
refreshing listings of a sub-directory of the directories dynamically based on the activity through the network stored on the storage device when an option is selected in the root level selection guide.

18. The method of claim 17 further comprising: automatically referencing a database having the activity through the network when creating the packet capture file.

19. The method of claim 17 wherein the criteria defines parameters that indicate network activity and which include at least one of an Ethernet source address, an Ethernet destination address, an Ethernet protocol from Ethernet header, a source IP address, a destination IP address, an IP flag, a header length, an IP protocol, an IP options (e.g., out of bound messages, may depend on application), a payload length, a next header, a source port, a destination port, a sequence number, an acknowledgement number, a TCP flag, and a TCP option from a TCP header, and a broadcast data.

20. The method of claim 16 further comprising removing certain ones of the formed directories when a sliding window of last recently used packets of the current and historical activity through the network are discarded from the storage device.
